(19) United States
(12) Patent Application Publication
(10) Pub. No.: US 2026/0098138 A1
(43) Pub. Date: Apr. 9, 2026

(54) METHOD OF FORMING A SOLID CELLULOSE FOAM

(71) Applicant: Stora Enso OYJ, Helsinki (FI)

(72) Inventors: Liga Viksne, Jelgavas novads (LV); Kristine Biteniece, Riga (LV)

(73) Assignee: Stora Enso OYJ, Helsinki (FI)

(21) Appl. No.: 19/112,444

(22) PCT Filed: Sep. 22, 2023
(86) PCT No.: PCT/IB2023/059375

§ 371 Date: Mar. 17, 2025

(30) Foreign Application Priority Data
Sep. 23, 2022 (SE) 2230303-6

(51) Int. Cl. C08J 9/00; C08K 5/09; C08K 5/17

(52) U.S. Cl. CPC C08J 9/0085; C08K 5/09; C08K 5/175; C08J 2201/02; C08J 2205/05; C08J 2301/02; C08J 2301/28

(57) ABSTRACT

The present invention relates to a method of forming at least one compressed region in a solid cellulose foam, said method comprising the step of: a) Providing a solid cellulose foam; b) Providing at least one cutting line of a predetermined depth of cut into at least one surface of said solid cellulose foam, whereby the at last one cutting line defining at least one pattern on said at least one surface; and c) Pressing at least one pressing tool into said at leas one pattern of said at least one surface of said cellulose foam thereby forming at le st one compressed region. The invention further relates to a solid cellulose foam product formed by the method.

### FIELD OF THE INVENTION

The present invention relates to method of forming a solid cellulose foam intended to be a packaging material for goods during storage and transportation.

The invention also relates to a product made of a formed solid cellulose foam.

### BACKGROUND INFORMATION

Practically all consumer goods need protective packaging to cushion the goods during storage and transportation. It is recognised that there are numerous solutions for packaging and cushioning various goods depending on the physical properties of the goods to be protected and the degree of protection required relating to its application.

Examples of these are polymeric foam materials for packaging, such as polyurethane foam (PU), polyethylene foams (PE), expanded polystyrene (EPS) or expanded polypropylene (EPP). Porous materials for this type of use have to be stable, low-weight and easy to manufacture. Due to the increased awareness of the need to use renewable materials, it is highly motivated to replace petroleum-based polymers with polymers from renewable resources.

There are many challenges with finding foam materials from renewable sources. Many bio-based foams have higher cost of production and lower mechanical performance, as well as poor stability in water or high temperatures, compared to established foams from oil-based sources. Bio-based and recyclable protective materials need to have the same excellent characteristics and properties as petroleum-based protective materials for being the first choice over petroleum-based materials.

Low weight and good shock absorption of the bio-based foams are examples of crucial characteristics. Also, the ability to customize the shape and the form of the bio-based foams to the shape and form of the goods to be protected by the protective material is of uttermost importance. Cellulose has shown to have a special potential, as the most abundant renewable natural polymer on earth, with its crystalline structure, and the availability of methods for preparing large volumes on an industrial scale.

Several biobased foams comprising cellulose have been described. WO20200011587 A1 describes a porous material that is prepared by aerating a paste comprising cellulose fibres and gluten and depositing the aerated paste in a mould where it is dried. WO2015036659 A1 describes a moulded fibrous product prepared by foaming an aqueous suspension of natural fibres in combination with synthetic fibres and surfactant, feeding the fibrous foam to a mould where it is dried to produce a dry fibrous product.

There still exists a need for protective and cushioning materials that are natural, bio-based and recyclable thereby allowing the materials to be fully recyclable in regular paper and board flows and to be part of a circular material flow in existing packaging waste management systems. The protective and cushioning materials need to fit various conversion methods and be designed for complex shapes of goods to be protected and allow optimised cushioning and packaging size.

### SUMMARY OF THE INVENTION

It is an object of the present invention to obviate at least some of the disadvantages in the prior art and to provide a method of forming at least one compressed region in a solid cellulose foam, as defined in claim 1.

Thanks to a method according to claim 1, a formed solid cellulose foam tailored for protecting goods of any shape may easily be prepared at a low cost.

An advantage with the method is that it is possible to create a multi-level cushioning material for the protection of goods of any shape from just one piece of cellulose foam, thus reducing the converting complexity as well as the material usage.

Providing at least one cutting line, which does not cut all the way through the foam but only to a certain depth of cut of said solid cellulose foam, followed by compressing through pressing an area defined by the at least one cutting line makes it possible to produce a protective material that offers a tight fitting around the shape of the goods to be protected and irrespective of the shape of the goods. The cutting lines also provide the compressed region with sharp, well-defined edges.

Another advantage with the method is that the at least one compressed region is still fixed to and integrated with uncompressed region/-s of said formed cellulose foam, i.e. there is no waste of cut-out material as there is by conventional methods.

In addition, said at least one compressed region will have a higher density than the corresponding uncompressed region/-s. A higher density correlates with a higher stiffness of the foam. In addition, the resilience of the compressed region will be higher than that of an uncompressed region. During e.g. transportation and storage it is important to hold any portion of the packed goods that requires extra protection, such as sharp edges and protruding parts, in place within the foam so as to avoid damages both on the packed goods and on the foam. Holding the packed goods in place is facilitated by providing the foam with compressed regions of higher stiffness and resilience.

However, compressing regions of the material too much or compressing the whole material will reduce a cushioning effect of the material, since the foam is deformed during compression. An advantage of the invention is that compression is tailored so that only certain regions are compressed (e.g. for sharp edges), and other regions are not compressed, or only compressed to a low degree, to ensure that the foam still has a sufficient cushioning effect.

Still another advantage is that the present method is easy to perform in a large scale set up.

Further aspects and embodiments are defined in the appended claims, which are specifically incorporated herein by reference.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

The invention will be described in more detail with reference to the enclosed figures, in which:

FIG. 1a shows a view oblique from above of a solid cellulose foam comprising cutting lines defining a pattern;

FIG. 1b shows said solid cellulose foam of FIG. 1a now comprising compressed regions;

FIG. 2 is a side view showing a solid cellulose foam comprising two compressed regions of different depths and volumes of said compressed regions;

FIG. 3a shows one half of a solid cellulose foam product comprising a compressed region and seen oblique from above, and

FIG. 3b shows a pressing tool for pressing a solid cellulose foam thereby forming the compressed region of the solid cellulose foam product as shown in FIG. 3a.

### DETAILED AND EXEMPLIFYING DESCRIPTION OF THE INVENTION

Before the invention is disclosed and described in detail, it is to be understood that this invention is not limited to particular compounds, configurations, method steps, substrates, and materials disclosed herein as such compounds, configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

Unless clearly indicated, all percentages are calculated by weight.

The expression “cutting line” as used herein denotes a cut made in a solid foam-based material. Said cutting line exhibits a certain depth in the material and is an only partially through-going cut.

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface active component, must be present to decrease surface tension. Finally, the foam must form more quickly than it breaks down.

The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “dry cellulose foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam may be at least 95 wt % as calculated based on the total weight of the solid cellulose foam. The shape and density of the solid cellulose foam is retained also in a non-confined state. The solid cellulose foam has an open cell structure, allowing air to occupy the pores within the foam. The solid cellulose foam can also be described as a porous material or a low-density material.

In a first aspect, the present invention provides for a method of forming at least one compressed region in a solid cellulose foam. In a second aspect, the present invention relates to a product made of a solid cellulose foam.

Said solid cellulose foam may preferably be prepared from a foam composition comprising:
a) from 71-95 wt % cellulose fibres, as calculated on the total weight of solid content of the composition,
b) from 4-24 wt % of a water-soluble thickener, as calculated on a total weight of solid content of the composition, and
c) at least two surfactants.

Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermos mechanical pulp (TMP) or chemo thermos mechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm. The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

The cellulose fibres of the foam composition may be selected from wood pulp; regenerated cellulose fibres; and plant fibres, such as fibres from bamboo, cotton, hemp, flax, and jute.

Preferably, the cellulose fibres are selected from wood pulp, such as softwood pulp, hardwood pulp, chemical-thermomechanical pulp, and from dissolving pulp, or a combination of one or more of these.

More preferred, the cellulose pulp fibres are selected from softwood pulp, chemical-thermomechanical pulp, or dissolving pulp.

Most preferred, the cellulose pulp fibres are selected from softwood pulp, such as softwood Kraft bleached pulp.

The water-soluble thickener may be present in an amount of from 4-24 wt %, or from 5-20 wt %, as calculated on the total weight of solid content of the foam. The thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof.

The foam preferably comprises a mixture of at least two surfactants. One of the at least two surfactants is preferably a fast-acting surfactant that during preparation of the foam quickly settle at the air-water interphase during mechanical agitation, which contributes to the formation of a foam with a high density and a high viscosity and thus enables a free-standing foam. A suitable surfactant for this purpose is an anionic surfactant, preferably a low-molecular weight anionic surfactant. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from high pKa fatty acids, such as from plant derived feedstock, e.g. tetradecanoic acid (myristic acid), sodium oleate, lauric acid, palmitic acid, and stearic acid; glucose based cosurfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. Tween® (e.g. Tween® 20, Tween® 80 and Tween® 85); and polyoxyethylene lauryl ethers, such as polyethylene glycol dodecyl ether, pentaethylene glycol monododecyl ether and octaethylene glycol monododecyl ether.

Said foam composition may preferably be prepared by a method comprising the steps of:
a) disintegrating cellulose fibres in water to obtain a slurry of cellulose fibres;
b) adding the thickener to the slurry obtained in a) to obtain a mixture of thickener and cellulose fibres in water;
c) adding the at least two surfactants to the mixture obtained in b) to obtain a fibre suspension;
d) aerating the suspension obtained in c) to obtain a wet foam, wherein the wet foam comprises 10-38 wt % cellulose fibres, 0.5-10 wt % of the water-soluble thickener, and 0.1-2 wt % surfactants, as calculated on the total weight of the wet foam, and wherein the wet foam has a density of from 140-500 kg/m³ and a yield stress of from 40 to 400 Pa;
e) drying the wet foam obtained in d) to obtain a dried cellulose foam.

The wet foam may be dried without using a mould, i.e. the wet foam is free-standing and retains its shape during drying without the need of a mould.

The wet foam is homogenous and has a good stability due to a small bubble size (typically below 100 μm) obtained when aerating the mixture of cellulose fibres, thickener and surfactants. The wet foam does not flocculate during processing. The average bubble size is largely maintained during any subsequent processing or drying steps and the cellulose fibres remain well dispersed. The resulting solid cellulose foam obtained by drying the wet foam will be homogenous in structure, strong, have good mechanical properties, a smooth surface and no defects. In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

Said dried cellulose foam obtained in step e) may be used as the solid cellulose foam.

Said dried cellulose foam obtained in step e) may be obtained by a method comprising: depositing discrete units of a cellulose foam on a surface to obtain a first foam deposition, depositing a wet cellulose foam between the discrete units to obtain a subsequent foam deposition, and drying the wet foam to obtain a solid foam wherein discrete units of a foam are embedded in a foam matrix. Said solid cellulose foam may then be used as the solid cellulose foam of claim 1 and its dependent claims.

However, said solid cellulose foam may be prepared by other methods than the above described without departing from the scope of the present invention. For example, said solid cellulose foam may be prepared by a single deposition of a wet foam into any desired shape. Optionally, any suitable restriction means, such as a mould or a frame, may be used.

Said solid cellulose foam may e.g. be prepared by depositing the foam composition on a forming portion of a conventional or, for the purpose suitably modified, paper machine for forming a foam web.

Irrespective of the methods for preparing the solid cellulose foam, said solid cellulose foam preferably has a solid content ranging from 95-100 wt %, or 98-100 wt %, as calculated on the total weight of said foam.

A density of the solid cellulose foam may be 10-80 kg/m³, preferably 10-60 kg/m³, and more preferred 20-50 kg/m³.

Said density of the solid cellulose foam may vary and hence be different at different locations. For example, when drying a cellulose foam composition, the dried cellulose foam will consist of a core comprising a homogeneous open-cell fibre network, and densified outer layers (i.e. upper surface, lower surface and side wall/-s). The reason to the higher density of the outer layers is that the fibres are packed more tightly and are partly oriented differently in these layers. The densified outer layers are thus formed during drying and will remain also in the dried solid cellulose foam.

Said densified outer layers have improved mechanical stability and strength as compared to said core.

Said solid cellulose foam preferably comprises said densified outer layers coinciding with upper surface, lower surface and optionally side wall/-s of said foam. The solid cellulose foam is commonly produced in large planks that are cut into smaller planks after drying. The large planks are typically thin, such as having a thickness in the range of from 1 to 20 cm, or from 1 to 10 cm, or from 1 to 5 cm, or from 4 to 6 cm, and cutting is preferably performed such that the thickness remains the same also after cutting. The densified outer layers on the upper surface and lower surface of the solid cellulose foam are thus preferably present also on the smaller planks, whereas the densified outer layers on the side walls may not be.

In some embodiments, a densified outer layer is present only on the upper surface.

Said solid cellulose foam preferably comprises 71-95 wt %, or more preferred 75-95 wt %, cellulose fibres, as calculated on a total weight of solid content of said foam.

The first aspect of the present invention, i.e. the method of forming at least one compressed region in a solid cellulose foam, is now to be described in detail in the following and with reference to the figures.

Said method of forming at least one compressed region in a solid cellulose foam comprises the steps of:
a) Providing a solid cellulose foam 1;
b) Providing at least one cutting line 2 of a predetermined depth of cut DC into at least one surface 11 of said solid cellulose foam 1, whereby the at least one cutting line 2 defining at least one pattern 3 on said at least one surface 11; and
c) Pressing at least one pressing tool 4 into said at least one pattern 3 of said at least one surface 11 of said cellulose foam 1 thereby forming at least one compressed region 12.

Said step a—providing a solid cellulose foam—comprises choosing the appropriate solid cellulose foam 1. Choices of e.g. dimensions, composition of the foam, and material properties, such as density, are to be made in relation to the item/goods to be packed.

Preferably, said solid cellulose foam comprises a) from 71-95 wt % cellulose fibres, as calculated on the total weight of solid content of the solid foam;
b) from 4-24 wt % of a water-soluble thickener, as calculated on the total weight of solid content of the solid foam, and
c) at least two surfactants.

Said cellulose fibres are preferably selected from wood pulp; regenerated cellulose fibres; and plant fibres; preferably selected from softwood pulp, such as softwood Kraft bleached pulp, chemi-thermo mechanical pulp (CTMP) and dissolving pulp or any combination thereof.

Said solid cellulose foam 1 may have a height H1, a width W1 and a length L1 describing a three-dimensional (3D) shape.

Said 3D shape may be a regular shape such as a cube, a diamond, or a pyramid, or an irregular shape. Said shape may be a cylinder having a height and a diameter.

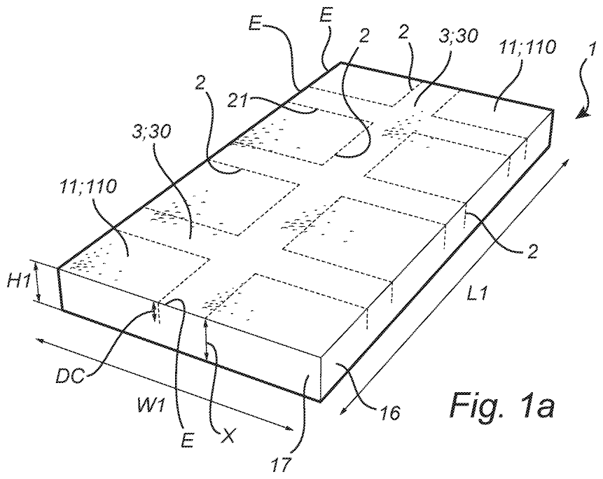

Said height H1 of said solid cellulose foam may be so small in relation to said length L1 and said width W1 that the three-dimensional shape has the shape of a board or plank, see FIGS. 1a and 1b.

Said solid cellulose foam may be further described as comprising an upper surface 110, a lower surface 14 and at least one wall 13. In the embodiment shown in FIGS. 1a and 1b said upper surface 110 and the at least one surface 11 defined in step b coincide.

It is to be understood that for embodiments wherein said solid cellulose foam comprises densified outer layers, said densified outer layers correspond to said upper surface 110, said lower surface 14 and optionally said at least one side wall 13.

The item/goods to be packed in and protected by the formed solid foam may e.g. be a flat piece of goods (small height in relation to length and width) or a three-dimensional piece of goods having a regular shape (e.g. a bottle) or having an irregular shape (e.g. a piece of art glass).

After having performed step a), i.e. providing the solid cellulose foam 1, step b) is performed.

Step b) comprises providing at least one cutting line 2 of a predetermined depth of cut DC into at least one surface 11 of said solid cellulose foam 1, whereby the at least one cutting line 2 defining at least one pattern 3 on said at least one surface 11.

Preferably, the at least one surface 11 comprises a densified layer. A densified layer provides the surface with improved strength.

Said solid cellulose foam 1 has a thickness that may vary or be constant. At parts where the at least one cutting line (2) is to be provided, said cellulose foam 1 has a thickness X; said thickness X is in an interval of 2-20 cm, preferably 2-10 cm, and most preferred 4-6 cm.

A cutting tool (not shown), e.g. a knife or a cutting blade or some other kind of relevant and sharp-edged cutting tool, is preferably arranged at a starting position near the at least one surface 11 intended to be cut into.

After having positioned the cutting tool in the proper starting position, the cutting tool is caused to be moved in a direction towards the at least one surface 11 of said solid foam 1. The movement causes the cutting tool to come into a direct contact with said at least one surface 11 and the movement of the cutting tool continues such that the cutting tool begins to cut into and through the surface/-s 11 and into the solid foam 1.

Said at least one cutting line 2 is arranged to partially cut through said thickness X (in some embodiments said thickness X is coinciding with the height H1, see FIG. 1a) of said solid cellulose foam to a predetermined depth of cut DC such that predetermined depth of cut DC is less than said thickness X of said cellulose foam 1.

The movement of the cutting tool (and the cutting operation) in said solid cellulose foam 1 continues until said predetermined depth of cut DC into the solid foam 1 is reached. The cutting tool is then removed from the solid foam 1 leaving a cutting line 2 in said solid cellulose foam 1. In FIG. 1a said cutting line 2 is shown as a dashed line running over said at least one surface 11, which in FIG. 1a is the upper surface 110, long side surfaces 16, and short side surfaces 17.

Said predetermined depth of cut DC of said at least one cutting line 2 is preferably 90% or less of said thickness X of said cellulose foam 1, more preferred 70% or less and most preferred 60% or less.

The cutting line 2 is preferably provided such that the depth of cut DC is perpendicular to the surface 11 onto which the cutting line 2 is provided.

In some embodiments, said cutting tool comprises two or more knives or blades. When using a cutting tool with two or more knives or blades, two or more patterns may be instantly cut in one and the same cutting operation, i.e. in one step. It is further conceivable that the two or more knives or blades perform cutting lines of different depth of cut DC.

There is also conceivable to use a cutting tool having only one knife or blade and to use two or more cutting tools of variable shape and depth of cut DC and repeating step b) for every cutting tool.

Repetition of step b), providing the at least one cutting line 2, may be performed before step c), the pressing step, or be alternated with pressing step c).

In some embodiments, the cutting tool may in its simplest form have a linear shape providing a linear cut 21.

In other embodiments, the cutting tool may be of a more complex shape and provide a curved cut 22 and/or a cut formed as a closed loop 23.

Said at least one cutting line 2 arranged on at least one surface 11 of said cellulose foam 1 defines at least one pattern 3 on said at least one surface 11 of said solid cellulose foam.

Said at least one pattern 3 may be formed as a closed loop defining a surface 30 having an area. Said loop may have any shape and may comprise corners and/or curves, e.g. rectangular, circular, square, oval, irregular etc.

In some embodiments, said surface 30 may be defined by one or more linear cutting line/-s 2 or by a combination of linear and curved cutting lines.

In other embodiments said surface 30 of said at least one pattern is defined by at least one cutting line 2 and at least one edge E of said cellulose foam 1 (See FIGS. 1a-b).

In further embodiments said surface 30 of said at least one pattern may be defined by at least one linear cutting line and at least one curved cutting line.

Step b) of the method is followed by a pressing step, step c).

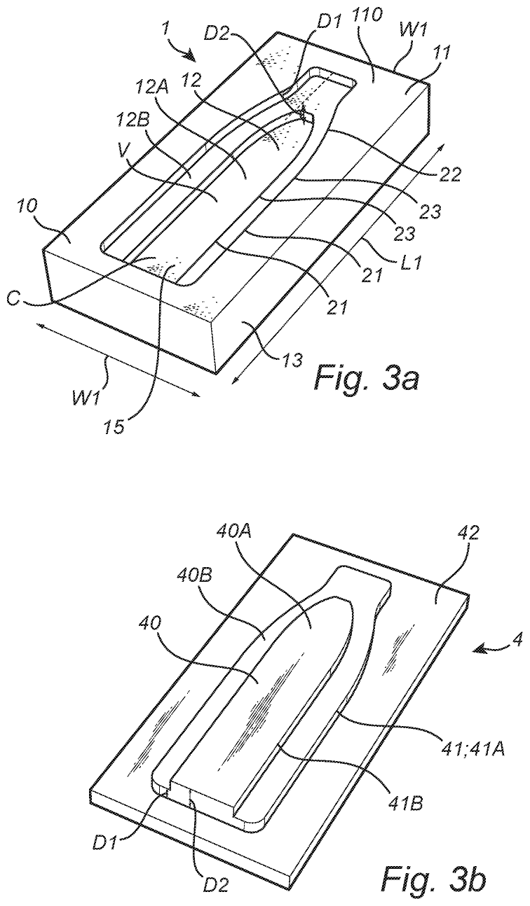

Step c) comprises pressing at least one pressing tool 4 (example of pressing tool is shown in FIG. 3b) into said surface 30 of said at least one pattern 3 of said at least one surface 11 of said cellulose foam 1 thereby forming at least one compressed region 12.

After pressing, the entire surface 30 delimited by the pattern 3 forms the compressed region 12. This means that the entire surface 30 delimited by the pattern 3 has been compressed. In some embodiments, the entire compressed region 12 has been compressed to the same extent. Alternatively, the degree of compression varies within the compressed region 12. The at least one cutting line 2 defines the pattern 3, and the cutting line(s) will thus form the edges of the compressed region 12. By the cutting line(s) forming the edges of the compressed region 12, sharp and well-defined edges are provided.

If instead pressing the cellulose foam 1 without first providing at least one cutting line 2, the compressed region 12 will not have sharp and well-defined edges. For example, the edges of the compressed region 12 of the cellulose foam 1 may crack during pressing with the pressing tool 4 such that the edges become uneven.

The pressing step c) preferably starts with positioning said at least one pressing tool 4 to a starting position near said at least one pattern 3 followed by causing said at least one pressing tool 4 to move towards said pattern 3 of said at least one surface 11 such that the at least one pressing tool 4 contacts said surface 30 of said pattern 3 and exerts a pressure on said surface 30 of said pattern 3 thereby compressing said material 1.

Said pressure exerted by said at least one pressing area 40 of said at least one pressing tool 4 causes said at least one pattern 3 to be compressed in a direction coinciding with a direction of said pressing, and further into a core of the solid cellulose foam 1.

Said pressing tool 4 is removed after having reached a predetermined depth 43 of compression by said pressing.

In FIGS. 1a and 1b, it is shown that the at least one compression 12 has been performed in a direction from the upper surface 110 towards the lower surface 14 and parallel or almost parallel to the height H1.

After having completed said at least one pressing step, at least one compressed region 12 has been formed in the solid cellulose foam 1.

Said at least one pressing tool 4 may preferably have at least one pressing area 40 that corresponds to or is smaller than said area/said surface 30 of the at least one pattern 3 of said at least one surface 11. Preferably, the pressing tool 4 has a pressing area 40 that corresponds to the surface 30 of the at least one pattern 3 of said at least one surface 11.

In some embodiments, said at least one pressing area 40 may comprise an edge line 41 surrounding said at least one pressing area 40 and said pressing edge line 41 may preferably be arranged to coincide with said at least one cutting line 2 during the pressing step.

Said edge line 41 may preferably be a right-angled edge line 41.

For items of a more complex shape said at least one pressing tool 4 may have more than one pressing area 40 (see FIG. 3a). In FIG. 3a said pressing area 40 comprises pressing areas 40A, 40B of different sizes.

Each pressing area 40A, 40B may in some embodiments have a respective pressing edge line 41A, 41B that is right-angled.

However, embodiments are conceivable where at least one of the pressing areas 40A, 40B may have a curved edge line.

Said pressing areas 40A, 40B of different sizes may also be of different shapes and arranged to penetrate and compress said at least one surface 11 to different pressing depths. Thicknesses of said pressing tool 4 corresponding to said different pressing depths D1, D2 are shown in FIGS. 3a and 3b and termed likewise.

In some embodiments, said pressing direction may be performed at an angle to the height H. In these embodiments it may be preferred that also the at least one cutting line 2 has the same angle to the height as the pressing direction. Preferably, the pressing direction is perpendicular, or almost perpendicular, to the at least one surface 11 that is to be compressed.

In some embodiments of the invention, step b) and step c) are performed simultaneously. The cutting tool and the pressing tool are one and the same tool, i.e. a combined tool performing both a cutting operation and pressing operation.

Said combined tool preferably comprises at least one sharp edge for providing said cutting and at least one pressing area for performing the compressing of the foam 1.

In embodiments where said combined tool is used and step b and step c are performed simultaneously into a combined step, it is conceivable to perform said combined step not only once but to repeat said combined step two or more times.

Irrespective of performing cutting and pressing as separate steps or as a combined step, said solid cellulose foam 1 now comprises at least one compressed region 12 and at least one uncompressed region 10.

Said at least one compressed region 12 comprises a compressed solid cellulose foam 15 having a compressed thickness CMT (best seen in FIG. 1b) and a void V of a specific volume.

In some embodiments, said pressing step is performed until a pressing depth equal to the predetermined depth of cut DC is reached, see FIG. 1b. For these embodiments, said compressed thickness CTM may be calculated as the thickness X of the cellulose foam 1 at the position for the at least one cutting line 2 minus the predetermined depth of cut DC of the cutting line 2:

$$CTM = X - DC$$

In other embodiments, said pressing depth PD may be less than or greater than said predetermined depth of cut DC. Preferably, the pressing depth PD is less than or equal to said predetermined depth of cut DC to ensure that the edges of the compressed region 12 are sharp and well-defined.

The solid cellulose foam 1 provided in step a) preferably has a uniform bulk density, and preferably also at least one densified layer. Pressing said at least one pressing tool 4 into said at least one pattern 3 of said foam 1 results in a higher density of said compressed solid cellulose foam 15 comprised in said at least one compressed region 12 than the density of the provided—and uncompressed—solid cellulose foam 1.

Preferably, the at least one cutting line 2 is provided into a surface 11 of the foam 1 that comprises a densified layer. The foam in the compressed region 12 thus also preferably comprises a densified layer.

Said density of the at least one compressed region 12 is preferably 10%-90% higher than a density of an uncompressed region of said solid cellulose foam 1, more preferred 20-90% and most preferred 40-90%.

In some embodiments said density of said compressed region 12 is 20-80% higher than said density of uncompressed region/-s.

When compressing the solid cellulose foam, the density in the compressed region will increase as discussed above. This will increase the stiffness and improve the resilience of the solid cellulose foam which is of importance e.g. in order to keep an item in place during storage and transportation. The uncompressed solid cellulose foam has excellent cushioning properties due to the shock-absorbing properties of the material. Upon compression, the cushioning properties of the solid cellulose foam however starts to decrease as the open-cell structure of the foam is deformed. If the degree of compression is high, such that the solid cellulose foam is compressed to about 30% or less of its original thickness, the cushioning properties may be severely affected. Thus, it is important to tailor the degree of compression depending on the goods or item to be protected.

Depending on the degree of compression, as well as other conditions such as relative humidity and time of compression, the solid cellulose foam may recover some or all of its original thickness when the pressing tool has been removed. This is in particular the case when the degree of compression is low, such that the solid cellulose foam is compressed to not more than 90% of its original thickness. The higher the degree of compression, the more deformation will occur in the foam and the ability to recover any of the original thickness will gradually decrease. In one embodiment, the optimal degree of compression is in the range of from 10 to 90%, such as from 20 to 80%, of the original thickness, resulting in no or slight recovery of the original thickness after removal of the pressing tool. However, the compressed foam will have an improved resilience as compared to the uncompressed foam. That is, the compressed foam will upon e.g. an impact be able to recover its compressed thickness to a high extent. This is of importance when it comes to hold a packed item in place, also during an impact.

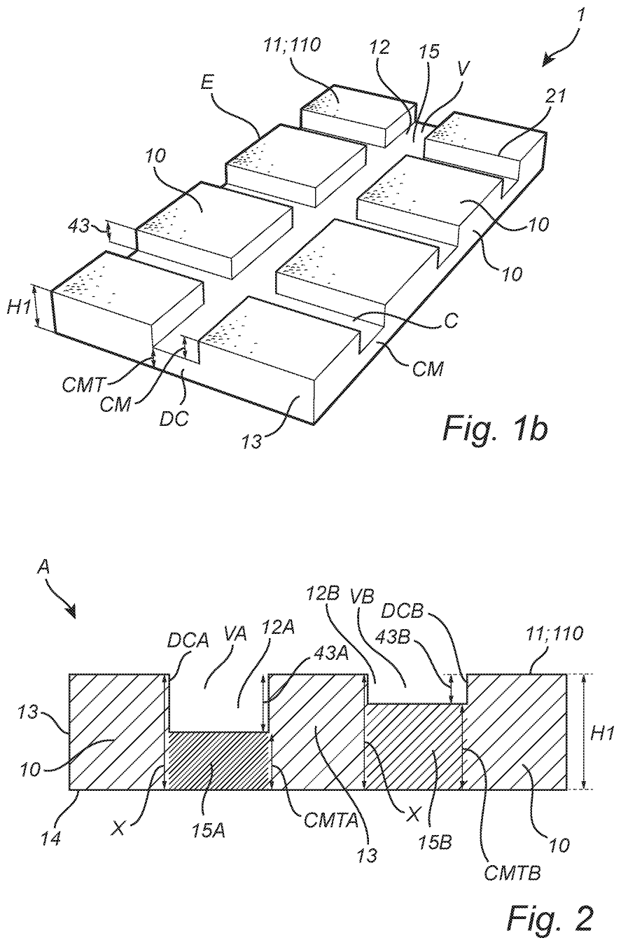

As shown in FIG. 2, said formed solid cellulose foam 1 may comprise compressed regions 12A, 12B that are of different sizes having different depths 43A, 43B causing said respective voids VA, VB to be of different volumes.

Said thickness of the compressed materials 15A, 15B in compressed regions 12A, 12B may also be different, and shown as CMTA and CMTB, respectively.

Different thicknesses CMTA, CMTB correspond to different densities of said compressed materials 15A, 15B.

Said at least one pressing tool 4 preferably has the same shape as a shape of at least a portion of the item to be protected by the formed cellulose foam.

In some embodiments the formed cellulose foam comprises two halves arranged to tightly fit around the outside of the item to be protected. Said halves may be identical or show differences.

Said pressing step may be repeated one or more times to provide said solid cellulose foam 1 with additional compressed regions 12.

In some embodiments it may be preferred to use a second pressing tool having a pressing area of another size than the area of a first pressing tool or having another shape than the shape of the first pressing tool, and to press the pressing tool with said another size/other shape into already compressed region/-s.

In some embodiments said at least one compressed region 12 extends to at least one edge E of said cellulose foam (FIGS. 1a-b).

In some embodiments said void V of said at least one compressed region 12 has the shape of a cavity, said cavity may not be in a direct contact with edges E of the solid cellulose foam 1 (as shown in FIG. 3a).

Embodiments are conceivable where said solid cellulose foam 1 comprises different types of compressed regions 12 on different parts of the solid foam 1, e.g. cavity regions and compressed regions extending to at least one edge E of said foam 1. It is the shape and design of the item to be protectively packed that determines the shape, the number and type of compressed regions.

Unlike pressing of thermo-plastic foams, said pressing may preferably be performed without any addition of heat. Neither the at least one pressing tool, nor the solid cellulose foam need to be heated. Since heating is not required, a simple and energy-efficient pressing process is enabled.

In a second aspect, the present invention relates to a product made of a solid cellulose foam, wherein said product comprises at least one compressed region.

Said compressed region 12 preferably a density that is at least 10% higher than a density of uncompressed region/-s, preferably 20-90%, more preferred 40-90%. Said density may even be higher, e.g. than 50% or more.

In some embodiments said density of said compressed region 12 is 20-80% higher than said density of uncompressed region/-s.

The solid cellulose foam 1 preferably comprises densified outer layers, such that the upper surface 110, the lower surface 14 and optionally the at least one side wall 113 of said foam comprise densified outer layers. Preferably, the surface 11, such as the upper surface 110, into which at least one cutting line 2 is provided and into which at least one compressed region 12 is formed, comprises a densified outer layer.

Said solid cellulose foam preferably comprises:
a) from 71-95 wt % cellulose fibres, as calculated on the total weight of solid content of the foam,
b) from 4-24 wt % of a water-soluble thickener, as calculated on the total weight of solid content of the foam, and
c) at least two surfactants.

The cellulose fibres of the product are selected from wood pulp; regenerated cellulose fibres; and plant fibres; preferably selected from softwood pulp, such as softwood Kraft bleached pulp, chemi-thermo mechanical pulp (CTMP) and dissolving pulp or a combination thereof.

In some embodiments said product comprises two or more parts arranged to be connected to each other to form a three-dimensional protective packing comprising at least one void V. Said at least one void V may in these embodiments preferably be a sum of the respective voids of the two or more parts.

FIG. 3a shows a half of a product comprising two identical halves and where the void V of each half together form a larger void when said two halves are connected to each other. The respective upper surfaces 110 of each half are arranged to be fixed to each other e.g. glued, after the item to be protected has been placed in a first of the halves and the second half has been arranged with its upper surface 110 to the corresponding surface 110 of the first half.

The inventive product may preferably be used as a protective cover of an item or goods to be packed. Fragile items may especially benefit from using the product as defined by the claims since the compressed regions provides additional support to hold the item or goods in place, enabling improved protection of the item, as it is held tightly in place by the compressed regions.

It is conceivable that the solid cellulose foam provided in step a) may be pre-compressed to some degree in order to e.g. increase the density and, hence, the strength of the solid cellulose foam and that the method step c) is performed on an already compressed foam.

It is understood that according to the inventive method and product, it is unwanted to have a through-going cutting line, i.e. that the cutting line has a depth of cut equal to (or almost equal to) the thickness X of the solid cellulose foam material 1. The reason to this is that it will not be possible to perform the pressing step c while at the same time keeping the compressed region 12 as a fixed and integrated part of the solid foam. Rather, the compressed region 12 would be a loosely fitted part comprised in the solid foam material 1 with a risk of loosen and leave the solid foam material which may cause the packed item to be subjected to impacts and shocks.

### EXAMPLES

### Example 1

A solid cellulose foam plank with a thickness of 45 mm was pre-cut into shapes having a surface area of 76×76 mm and varying depth (table 1, “cut depth”). The pre-cut pattern of the cellulose foam plank was then manually pressed using a 2 kg weight having a pressing area corresponding to the surface area of the pre-cut pattern. The cellulose foam was dry, had a density in the range of from 32 to 35 kg/m³ and comprised from 83 to 88 wt % cellulose fibres (softwood bleached Kraft pulp), from 10 to 15 wt % thickener (CMC) and about 2 wt % surfactant (mixture of myristic acid and sodium cocoyl sarcosinate). No heat was applied during pressing.

The weight was pressed to various depths for varying times (table 1, “depth of pressure”). After pressing, the weight was removed. The thickness of the foam in the compressed region was measured 30 seconds (table 1, “depth after 30 sec”) and 24 hours (table 1, “depth after 24 hours”) after removal of the pressure.

The results are summarized in table 1. All depths are measured as the height of the remaining foam measured from the bottom of the plank.

TABLE 1

| | | pressing | depth of | depth after | depth after |
|---|---|---|---|---|---|
| sample | cut depth | time | pressure | 30 sec | 24 hours |
| 1 | 20 | 10 sec | 25 | 30 | 33 |
| 2 | 20 | 1 min | 25 | 30 | 31 |
| 3 | 20 | 10 min | 25 | 27 | 29 |
| 4 | 20 | 30 min | 25 | 25 | 28 |
| 5 | 10 | 10 sec | 20 | 25 | 27 |
| 6 | 20 | 10 sec | 25 | 25 | 28 |
| 7 | 30 | 10 sec | 30 | 30 | 30 |
| 8 | 40 | 10 sec | 40 | 40 | 40 |

A cellulose foam plank can be pressed to various depths, the shape remains also after removal of the pressure. Due to the pre-cutting, all edges of the pressed regions are sharp and well-defined.

As will be understood by those skilled in the present field of art, numerous changes and modifications may be made to the above described and other embodiments of the present invention, without departing from the scope of the present invention as defined in the appending claims.

It should be noted that the above described aspects may be the subject for its own protection, as such in a separate divisional application. Hence, it is foreseen that this aspect of the invention may require a protection by its own, e.g. since it may be applicable per se also in other concepts than that defined by the independent claim in this application.

1. A method of forming at least one compressed region in a solid cellulose foam, said method comprising the steps of:
a. providing a solid cellulose foam;
b. providing at least one cutting line of a predetermined depth of cut into at least one surface of said solid cellulose foam, whereby the at least one cutting line defines at least one pattern on said at least one surface; and
c. pressing at least one pressing tool into said at least one pattern of said at least one surface of said cellulose foam thereby forming at least one compressed region.

2. The method according to claim 1, wherein said at least one cutting line partially cuts through a thickness of said cellulose foam such that said predetermined depth of cut is less than said thickness of said cellulose foam.

3. The method according to claim 2, wherein said predetermined depth of cut of said at least one cutting line is 90% or less of said thickness of said cellulose foam.

4. The method according to claim 1, wherein said pressing is performed without heating said at least one pressing tool and said cellulose foam.

5. The method according to claim 1, wherein said at least one pressing tool has a pressing area that corresponds to or is smaller than an area of the at least one pattern of said at least one surface.

6. The method according to claim 1, wherein a density of an uncompressed region of said solid cellulose foam is in a range of 10-80 kg/m³.

7. The method according to claim 1, wherein said solid cellulose foam comprises densified outer layers.

8. The method according to claim 1, wherein a density of said at least one compressed region is higher than the density of said solid cellulose foam-provided in step a).

9. The method according to claim 1, wherein said density of the at least one compressed region is preferably 10% % higher than a density of an uncompressed region of said solid cellulose foam, more preferred 20-90% and most preferred 40-90%.

10. The method according to claim 1, wherein said at least one cutting line defines a closed loop.

11. The method according to claim 1, wherein said at least one compressed region has a shape of a cavity.

12. The method according to claim 1, wherein said at least one compressed region extends to at least one edge of said cellulose foam.

13. The method according to claim 1, wherein said at least one pressing tool is pressed into said cellulose foam to a pressing depth less than or equal to said predetermined depth of cut of said at least one cutting line.

14. The method according to claim 1, wherein said solid cellulose foam comprises:
d. from 71-95 wt % cellulose fibres, as calculated on a total weight of solid content of said solid cellulose foam,
e. from 4-24 wt % of a water-soluble thickener, as calculated on the total weight of solid content of said solid cellulose foam, and
f. at least two surfactants.

15. The method according to claim 14, wherein the cellulose fibres are selected from a group consisting of: wood pulp; regenerated cellulose fibres; and plant fibres.

16. A product comprising:
a solid cellulose foam,
wherein said product comprises at least one compressed region having a density that is between 10% % higher than a density of an uncompressed region of said solid cellulose foam.

17. The product according to claim 16, wherein said solid cellulose foam comprises:
g. from 71-95 wt % cellulose fibres, as calculated on a total weight of solid content of said solid cellulose foam material,
h. from 4-24 wt % of a water-soluble thickener, as calculated on the total weight of solid content of the solid cellulose foam material, and
i. at least two surfactants.

18. The product according to claim 17, wherein the cellulose fibres are selected from a group consisting of: wood pulp; regenerated cellulose fibres; and plant fibres.

19. The product according to claim 16, wherein said product comprises two or more parts configured to be connected to each other to form a three-dimensional protective packing comprising at least one void.

20. The method according to claim 14, wherein the cellulose fibres are from a pulp selected from a group consisting of: softwood pulp, chemi-thermo mechanical pulp, dissolved pulp, and combinations thereof.
